(19) United States
(12) Patent Application Publication
(10) Pub. No.: US 2024/0147914 A1
(43) Pub. Date: May 9, 2024

(54) METHOD AND SYSTEM FOR PROVIDING LIGHT TO A CANNABIS PLANT

(71) Applicant: SIGNIFY HOLDING B.V., EINDHOVEN (NL)

(72) Inventors: MARCELLINUS PETRUS CAROLUS MICHAEL KRIJN, EINDHOVEN (NL); CÉLINE CATERINE SARH NICOLE, EINDHOVEN (NL)

(21) Appl. No.: 18/281,268

(22) PCT Filed: Mar. 7, 2022
(86) PCT No.: PCT/EP2022/055668

§ 371 Date: Sep. 8, 2023

(30) Foreign Application Priority Data
Mar. 11, 2021 (EP) 21162007.5

(51) Int. Cl. A01G 7/04; A01G 9/24

(52) U.S. Cl. CPC A01G 7/045; A01G 9/249

(57) ABSTRACT

A method for providing light to a Cannabis plant is disclosed. The method comprises, during a first time period of a flowering stage of the Cannabis plant, the first time period being one or more days, controlling a horticultural illumination system to provide horticulture light to the Cannabis plant such that the Cannabis plant is exposed to a first photoperiod. The method further comprises, thereafter, during a second time period of the flowering stage of the Cannabis plant, the second time period being one or more days, controlling the horticultural illumination system to provide horticulture light to the Cannabis plant such that the Cannabis plant is exposed to a second photoperiod. Herein, the second photoperiod is longer than the first photoperiod.

### FIELD OF THE INVENTION

This disclosure relates to a method and system for providing light to a Cannabis plant. In particular to such method and system wherein a photoperiod is increased during a flowering stage of the Cannabis plant. This disclosure further relates to a computer program and storage medium for such method and/or system.

### BACKGROUND

Cannabis sativa is a flowering annual plant whose phytochemical by-products are prescribed to relieve the symptoms of a medical condition, such as relieving pain and prevent nausea. An example of such by-product is CBD (cannabidiol). Furthermore, it has anti-inflammatory and antioxidant properties. As many countries have intentions to legalize the medical use of Cannabis, the amount of harvested Cannabis per year is expected to increase considerably.

Medicinal Cannabis needs to be grown under controlled circumstances to be able to guarantee a sufficiently constant quality and reproducibility. To this end, growth mostly takes place in a greenhouse or indoors (i.e. without daylight). For optimum quality (e.g. optimal and reproducible phytochemical content), supplemental light is used (e.g. based on LED lighting).

Flowering of a Cannabis plant is typically induced by shortening the photoperiod applied to the Cannabis plant— from for example 18 hours per day during the vegetative phase of the plant— to approximately 12 hours per day and subsequently keeping it constant at this value, until harvest. Typically, all the flowers of the whole plant are harvested at the same time.

Understandably, Cannabis farmers strive to increase the yield, and strive to increase the amount of harvested product per unit of time. To this end, Cannabis farmers employ techniques to shorten the time it takes for Cannabis plants to fully develop and produce fully developed Cannabis flowers ready for harvest. In addition, Cannabis farmers aim to increase the amount of harvested product per plant, for example by ensuring that the plants receive proper nutrition. However, the current state of the art still leaves room for improving the yield of a Cannabis farm.

WO 2020/254241 A1 discloses a lighting method for providing light to a Cannabis plant during at least a flowering stage of the Cannabis plant, the method comprising: providing the horticulture light to the Cannabis plant during the flowering stage according to a flowering stage time scheme, wherein the flowering stage time scheme lasts n_{f} weeks and includes a flowering stage on-off schedule of the horticulture light wherein during each 24 hours the on-time is at least 10 hours and the off-time is at least 10 hours, except for k_{f} deviations from the flowering stage on-off schedule of the flowering stage time scheme, wherein each deviation includes an on-time selected from the range of 24-72 hours, wherein n_{f} is at least 6, and wherein k_{f} is selected from the range of 1≤k_{f}≤n_{f}.

### SUMMARY

Therefore, a method for providing light to a Cannabis plant is disclosed. The method comprises, during a first time period of a flowering stage of the Cannabis plant, the first time period being one or more days, controlling a horticultural illumination system to provide horticulture light to the Cannabis plant such that the Cannabis plant is exposed to a first photoperiod. The method further comprises, thereafter, during a second time period of the flowering stage of the Cannabis plant, the second time period being one or more days, controlling the horticultural illumination system to provide horticulture light to the Cannabis plant such that the Cannabis plant is exposed to a second photoperiod. Herein, the second photoperiod is longer than the first photoperiod.

The inventors have realized that during the flowering stage of a Cannabis plant, the photoperiod can be increased without necessarily causing the Cannabis plant to revert back to a vegetative phase. As a result of the increased photoperiod, the flowers of the Cannabis plant develop faster which enables shorter production cycles. As a further advantage, the usage of the horticulture illumination system increases as its operational hours per day increase and therefore the return on investment for the horticulture lighting system increases. Additionally or alternatively, this method enables the use of lower intensity light sources, compared to prior art, while still being able to provide the plant with an equal or sufficient total amount of photosynthetically active radiation over the course of the flowering stage. The light sources will namely be switched on for longer times with respect to the prior art.

In an embodiment, the Cannabis plant is a Cannabis Sativa plant or a Cannabis Sativa L. plant, or indica plant.

The first and second time periods may be subsequent time periods in that the second time period directly follows the first time period. Alternatively, there may be a time period between the first and second time period.

A “photoperiod” referred to in this disclosure may be understood as an amount of time per day that a plant is exposed to light. As used herein, “day” may be understood to refer to a period of 24 hours and does not necessarily relate to sunrise or sunset. Additionally or alternatively, “day” may be understood to be a period of an artificially created circadian rhythm of a plant, which may or may not be a 24 hr rhythm. Irrespective of whether reference is made to a 24 hr daily cycle, the photoperiod may be understood to define the duration of light versus darkness within a particular time span. In greenhouses the circadian rhythm of a plant syncs with the solar day. In vertical farming, without any daylight, growers might deviate from the 24 hr solar cycle and for example condition the plant towards a 23 hr circadian cycle, at the end shortening the time to harvest. If such 23 hr circadian cycle is used, then the photoperiod may be understood as an amount of time that a plant is exposed to light per 23 hours. For simplicity, and unless explicitly stated otherwise, when a photoperiod in this disclosure is said to have some duration, then this should be understood as that the plant is exposed to light for that duration out of a 24 hour period. A photoperiod is generally less than 24 hours. For example, when a photoperiod in this disclosure is said to be 16 hours, then this should be understood as that the plant is exposed to light 16 hours out of a 24 hour period, i.e. the plant is exposed to 16 hours of light and 8 hours of darkness in a 24 h period. Photoperiods used or referred to in this disclosure are generally shorter that their corresponding “day” cycle, i.e., the 24 hour cycle or the plant's circadian cycle, and therefore generally include a time of darkness within the “day” cycle.

The provided horticulture light is preferably configured to stimulate growth and development of the Cannabis plant and/or the Cannabis flower. Typically, such horticulture light is high intensity light, which may be provided by high-pressure sodium (HPS) lamps of 600 W or 1000 W or by LED luminaires able to generate light having a Photosynthetic Photon Flux Density (PPFD) of at least 800 μmol/s/m². Horticulture light is preferably photosynthetically active light, which may be understood as that photosynthetic organisms are able to use the horticulture light in the process of photosynthesis. Horticulture light may therefore also be referred to as PAR (Photosynthetically Active Radiation) light and may have wavelengths between approximately 400 and 700 nm. Additionally or alternatively, the horticulture light may include light just outside the PAR wavelength range such as far-red light which is understood as light in the wavelength range from 700 to 800 nm, especially between approximately 700 and 750 nm. In examples, horticulture light is understood to have a light spectrum comprising at least one of blue light, red light and/or far-red light.

Table 1 below shows five embodiments of horticulture light having five respective spectra.

TABLE 1
horticulture light radiant power distribution per spectral range

| | 400-499 | 500-599 | 600-699 | 700-799 |
|---|---|---|---|---|
| | nm | nm | nm | nm |
| Horticulture light #1 | 6% | 6% | 87% | 1% |
| DRWLB | | | | |
| Horticulture light #2 | 10% | 18% | 61% | 11% |
| DRWMB_FR | | | | |
| Horticulture light #3 | 13% | 5% | 81% | 1% |
| DRWMB | | | | |
| Horticulture light #4 | 21% | 6% | 72% | 1% |
| DRWHB | | | | |
| Horticulture light #5 | 20% | 37% | 41% | 2% |
| VSN2 | | | | |

Legend: DR = deep red; B = blue; W = white; FR = far-red; LB = low blue; MB = medium blue; VSN2 = visible wide spectrum.

The total radiant power of the horticulture light may be understood as the total radiant power of the light having a wavelength between 400 and 800 nm. The radiant power of the 400-499 nm light for example accounts for 0-25% of the horticulture light's total radiant power. The radiant power of the 500-599 nm light for example accounts for 0-50% of the horticulture light's total radiant power. The radiant power of the 600-699 nm light for example accounts for 25-95% of the horticulture light's total radiant power. The radiant power of the 700-799 nm light for example accounts for 0-30% of the horticulture light's total radiant power.

The flowering stage of a Cannabis plant may be defined as the period from the start of the induction of flowering until harvest of the Cannabis plant or the Cannabis flowers.

In an embodiment, the method comprises, during a third time period of the flowering stage of the Cannabis plant, the third time period occurring later than the second time period, the third time period being one or more days, controlling the horticultural illumination system to provide horticulture light to the Cannabis plant such that the Cannabis plant is exposed to a third photoperiod, wherein the third photoperiod is longer than the second photoperiod.

This embodiment enables to even further increase the rate with which flowers develop and thus shorten the time to harvest. This embodiment thus enables to increase a long-term yield of a medicinal Cannabis farm.

The first, second and third time periods may be subsequent time periods in that the second time period directly follows the first time period and the third time period directly follows the second time period. Alternatively, there may a time period between the first and second time period as well as a time period between the second and third time period.

In an embodiment, the first photoperiod is between 10 hours and 14 hours, preferably between 11 hours and 13 hours, more preferably approximately 12 hours. The first photoperiod may be configured to induce the flowering of the Cannabis plant and thus to initiate the flowering stage of the Cannabis plant.

In an embodiment, the second photoperiod is between 1 and 5 hours longer than said first photoperiod, preferably between 2 and 4 hours longer. This embodiment substantially increases the amount of light that the Cannabis plant receives per day during the flowering stage.

The first time period may last for 2 to 6 weeks.

In an embodiment, the flowering stage consist of N subsequent time periods {n_₁; n_₂; . . . ; n__{N-1}; n__{N}}, N being an integer number higher than 1. In this embodiment, the first time period is any of the time periods {n_₁; n_₂; . . . ; n__{N-1}} and the second time period is any of the time periods {n_₂; . . . ; n__{N-1}; n__{N}} after the first time period. In this embodiment, the method comprises, during each time period, controlling the horticultural illumination system to provide horticulture light to the Cannabis plant such that the Cannabis plant is exposed to a photoperiod tₖ, wherein k is an integer number and tₖ indicates the photoperiod for the k^{th} time period of the N subsequent time periods. In this embodiment, for at least a pair of time periods consisting of time period nₖ and subsequent time period nₖ₊₁, tₖ₊₁ is different from tₖ.

Each of the time periods may be one or more days.

Preferably, for at least a pair of time periods consisting of time period nₖ and subsequent time period nₖ₊₁, tₖ₊₁>tₖ.

In an embodiment, for at least two pairs of time periods, each pair consisting of a time period nₖ and a subsequent time period nₖ₊₁, tk₊₁>tₖ for each pair.

In an embodiment, for three subsequent time periods nₖ, nₖ₊₁ and nₖ₊₂, tk₊₁<tₖ and tₖ₊₂>tk₊₁. tₖ₊₂ may be equal to, shorter than or longer than tₖ. Thus, in this embodiment, the photoperiod may also be reduced at some point in time during the flowering stage, which may be used to draw the Cannabis plant back into the flowering stage in period nₖ₊₁ after an attempt of the Cannabis plant to revert to the vegetative stage in period nₖ, for example because the period nₖ (of increases photoperiod) was introduced too soon after induction of the flowering stage or the increase itself of the photoperiod was too high.

In an embodiment, for at least a trio of subsequent time periods consisting of time period nₖ and subsequent time period nₖ₊₁ and subsequent time period nₖ₊₂, tₖ₊₂>tₖ₊₁>tₖ.

In an embodiment, for at least four subsequent time periods consisting of time period nₖ and subsequent time period nₖ₊₁ and subsequent time period nₖ₊₂ and subsequent time period nₖ₊₃, tₖ₊₃>tₖ₊₂>tₖ₊₁>tₖ.

In an embodiment, for any pair of consisting of time period nₖ and subsequent time period nₖ₊₁, tₖ₊₁>tₖ. Thus, in this embodiment, the photoperiod increases for each next time period.

The photoperiod may be increased gradually with each next time period, for example such that the photoperiod of the next time period is at most 3 hours longer than the current photoperiod, preferably at most 2 hours longer than the current photoperiod.

In an embodiment, t_{N}>15 hours, preferably wherein t_{N}>16 hours. t_{N} is the photoperiod during the last time period in the flowering stage and before harvest of the plant. The inventors have found that the photoperiod can be, optionally gradually, increased so that a photoperiod of 16 hours is possible during a last one or more days before harvest. Hence, a high amount of photosynthetically active radiation can be provided to the Cannabis plant during the last time period of the flowering stage, herewith speeding up further the development of the Cannabis plant and Cannabis flowers as well as improving the quality of the harvest.

An increase in photoperiod from a first photoperiod to a second photoperiod may also be referred to as a photoperiod extension wherein additional hours of horticulture light are provided to the Cannabis plant. In embodiments, a photoperiod extension or photoperiod increase comprises providing the additional hours of horticulture light with a different spectral composition than the spectal composition of the horticulture light provided in the original photoperiod. For example, when the flowering stage of the Cannabis plant is induced by applying, during an initial time period of the flowering stage, an initial horticulture light spectrum with an initial photoperiod, then subsequent increases in photoperiod during subsequent time periods may be realized by extending the initial photoperiod with additional hours of applying additional horticulture light during the photoperiod extension, wherein a spectral composition of the additional horticulture light is different from a spectral composition of the initial horticulture light. The initial horticulture light may for example be selected from Table 1 above; the additional horticulture light may be selected from blue light, red light and white light. Although photoperiod extensions in the flowering phase using blue, red or white light all show improved yield—in terms of Cannabis flower fresh weight or dry weight—compared to applying one photoperiod and one horticulture light spectral composition throughout the flowering phase, it has been shown that photoperiod extensions with red light generates the highest yield. Therefore, photoperiod extensions in the flowering phase of a Cannabis plant are preferably realized by providing red light during additional hours of the photoperiod extension.

It is therefore an aspect of the invention to provide a method further comprising controlling the horticultural illumination system to provide, during at least part of the second photoperiod, horticulture light with a different spectral composition compared to the horticulture light provided during the first photoperiod. In embodiments, the at least part of the second photoperiod comprises a photoperiod extension, defined as additional hours of exposing the Cannabis plant to horticulture light during the second photoperiod compared to the first photoperiod. Preferably the horticulture light with the different spectral composition, applied during the photoperiod extension, is red or blue light.

In an embodiment, the method comprises, during the first time period, determining a sensitivity value of the Cannabis plant to the photoperiod. In such embodiment, the method comprises, based on a determination that the determined sensitivity value is below a threshold sensitivity value, starting the second time period and controlling the horticultural illumination system to provide horticulture light to the Cannabis plant such that the Cannabis plant is exposed to the second photoperiod.

If a Cannabis plant is sensitive to the photoperiod, then increasing the photoperiod may cause the plant to revert back to the vegetative state, which negatively influences the quality of the harvested flowers as well as the speed with which the flowers develop towards a state in which they are ready for harvest. This embodiment enables to reduce the risk of such reversion from the flowering stage of the plant to the vegetative state of the plant.

If a Cannabis plant is said to be relatively sensitive to the photoperiod, this may be understood as that a change in the photoperiod has a relatively large impact on the development of the Cannabis plant, for example in the sense that the change in the photoperiod causes the plant to revert back to the vegetative phase. If a Cannabis plant is said to be relatively insensitive to the photoperiod, this may be understood as that a change in the photoperiod has a relatively small impact on the development of the Cannabis plant, for example in the sense that the change in the photoperiod does not cause the plant to revert back to the vegetative phase.

The sensitivity value indicates a sensitivity of the Cannabis plant to the photoperiod and may be determined by measuring at least once, but preferably by measuring repeatedly, a current physiological state of the Cannabis plant, such as the current height, stem diameter, growth rate, leave length, internode length. The sensitivity value may be determined by measuring such physiological states at respective times and determining the sensitivity value based on a rate of change of the measured state. In a particular example, the sensitivity value may be determined based on a rate of change of the height of the plant and/or length of the plant's main stem and/or stem diameter. Alternatively, the sensitivity value of the plant may be determined based on known data that defines, for example for a particular species of Cannabis, the time at which it becomes insensitive enough for the photoperiod to be increased without the risk of the plant reverting back to the vegetative phase.

In an example, based on the determination that the determined sensitivity value is below a threshold sensitivity value, the photoperiod is increased.

In an embodiment, the method comprises, during the first time period, determining a growth of a diameter of a stem per unit of time of the Cannabis plant, and, based on the determined diameter growth, determining the sensitivity of the Cannabis plant to the photoperiod.

The inventors have realized that the stem diameter growth can provide an indication as to how sensitive the Cannabis plant is to a change in the photoperiod. In particular, a relatively low resp. high growth rate of the stem's diameter may indicate a relatively low resp. high sensitivity to the photoperiod. This embodiment enables to more accurately and reliably determine the sensitivity of the Cannabis plant to the photoperiod at any given time.

In an embodiment, the method comprises during the first time period, determining a growth of a length of the Cannabis plant per unit of time, and, based on the determined length growth, determining the sensitivity of the Cannabis plant to the photoperiod.

This embodiment provides an additional method for determining the sensitivity of the Cannabis plant to the photoperiod. Advantageously, this embodiment allows to determine more accurately the sensitivity to the photoperiod at any given time. Further, the length of the Cannabis plant is easily measured. Hence, the sensitivity to the photoperiod can be determined in a straightforward manner, for example based on one or more images as explained below.

The length of the Cannabis pant referred to herein may be a height of the Cannabis plant. Alternatively, the length of the Cannabis plant may refer to a total length of the main stem of the Cannabis plant not including the root.

In an embodiment, determining the growth of the diameter of the stem per unit of time and/or the growth of the length per unit of time comprises determining the growth of the diameter of the stem per unit of time and/or the growth of the length per unit of time based on one or more images representing at least part of the Cannabis plant.

The Cannabis plants may be monitored using a camera system that records the plants. Image processing may subsequently be employed to monitor the growth of the stem diameter and/or the growth of the plant's length over time.

Another aspect of this disclosure relates to a system for providing light to a Cannabis plant. The system comprises a horticulture illumination system configured to provide horticulture light to the Cannabis plant. The system further comprises a control system that is configured to, during a first time period of a flowering stage of the Cannabis plant, the first time period being one or more days, control the horticultural illumination system to provide horticulture light to the Cannabis plant such that the Cannabis plant is exposed to a first photoperiod, and configured to, thereafter, during a second time period of the flowering stage of the Cannabis plant, the second time period being one or more days, control the horticultural illumination system to provide horticulture light to the Cannabis plant such that the Cannabis plant is exposed to a second photoperiod. Herein, the second photoperiod is longer than the first photoperiod.

It should be appreciated that the control system may be configured to perform any of the method steps described herein. For example, the control system may be configured to determine a sensitivity of the Cannabis plant to the photoperiod by performing any of the determination methods or steps as described herein. Further, the control system may be configured to receive one or more images of at least a part of the Cannabis plant based on which it can determine the sensitivity to the photoperiod.

In an embodiment, the control system comprises an imaging system, such as a camera system, that is configured to capture a plurality of images of at least part of the Cannabis plant. Such imaging system may then be configured to send the captured images to the control system so that it can determine the sensitivity to the photoperiod.

The control system may be configured to control any of the elements described herein in addition to the horticulture illumination system, such as the imaging system, in such manner that it captures a plurality of images.

Another aspect of this disclosure relates to a computer program comprising instructions which, when the program is executed by the control system of any of the systems described herein, causes such system to perform any of the methods described herein. The computer program may comprise a suite of computer programs comprising at least one software code portion, the software code portion, when executed by the control system of any of the systems described herein, causes such system to perform any of the methods described herein.

Another aspect of this disclosure relates to a non-transitory computer-readable storage medium having stored thereon any of the computer programs or software code portions described herein.

Another aspect of this disclosure relates to a control system comprising (a) a computer readable storage medium having a computer readable program embodied therewith, and (b) a processor, preferably a microprocessor, coupled to the computer readable storage medium, wherein responsive to executing the computer readable program, the processor is configured to perform any of the methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In one aspect, embodiments of the present invention may relate to a computer-implemented method for controlling a horticulture illumination system as described herein.

Moreover, a computer program for carrying out the methods described herein, as well as a non-transitory computer readable storage-medium storing the computer program are provided. A computer program may, for example, be downloaded (updated) to the existing data processing systems (e.g. to the existing control systems) or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a diagram illustrating a lighting scheme according to the prior art;

FIG. 2A is a diagram illustrating a lighting scheme according to an embodiment;

FIG. 2B is a diagram illustrating a lighting scheme according to an embodiment wherein the photoperiod is gradually increased during the flowering stage;

FIG. 2C is a diagram illustrating a lighting scheme according to an embodiment wherein the photoperiod is reduced at least once during the flowering stage;

FIG. 3 is a diagram illustrating a lighting scheme according to an embodiment wherein the photoperiod is varied in a continuous manner, e.g. each day;

FIG. 4 illustrates a system according to an embodiment;

FIG. 5A is a flow chart illustrating a method according to an embodiment;

FIG. 5B is a flow chart illustrating a method according to an embodiment that comprises analysing captured images;

FIG. 6 is a chart illustrating a typical growth rate variation over time;

FIG. 7 illustrates a data processing system according to an embodiment

FIGS. 8A-8C illustrate results from experiments of growing Cannabis plants using methods according to embodiments using different lighting schemes;

FIG. 9 illustrates results from experiments of growing Cannabis plants using methods according to embodiments using different lighting schemes and blue light provided during photoperiod extensions;

FIGS. 10A-10B illustrate results from experiments of growing Cannabis plants using methods according to embodiments using different spectral compositions of horticulture light provided during photoperiod extensions.

### DETAILED DESCRIPTION OF THE DRAWINGS

In the figures, identical reference numbers indicate similar or identical elements.

A typical growth cycle of a Cannabis plant in a commercial greenhouse or indoor setting consists of several distinguishable growth phases:
1. Young plants are propagated from seeds or from cuttings taken from a female mother plant. This is the seedling phase or propagation phase.
2. Next, the seedlings are transplanted to a lower plant density to allow sufficient space to grow and then grown to a certain degree of maturity. This is called the vegetative phase.
3. After the vegetative phase there is a flowering phase that starts with a transition to the reproductive phase (i.e. flowering). Cannabis plants are so-called short-day plants. They start flowering when the photoperiod is shortened.

To induce flowering, the photoperiod is shortened to typically 12 hours per day. This photoperiod is kept constant at this value during the remainder of the flowering phase, until harvest. During this phase, the supplemental light level used is relatively high (typically 1000 μmol/s/m²).

The flowering phase is the longest phase in the life cycle of the Cannabis plant. The flowers are harvested, dried, and processed to extract the phytochemical content of interest.

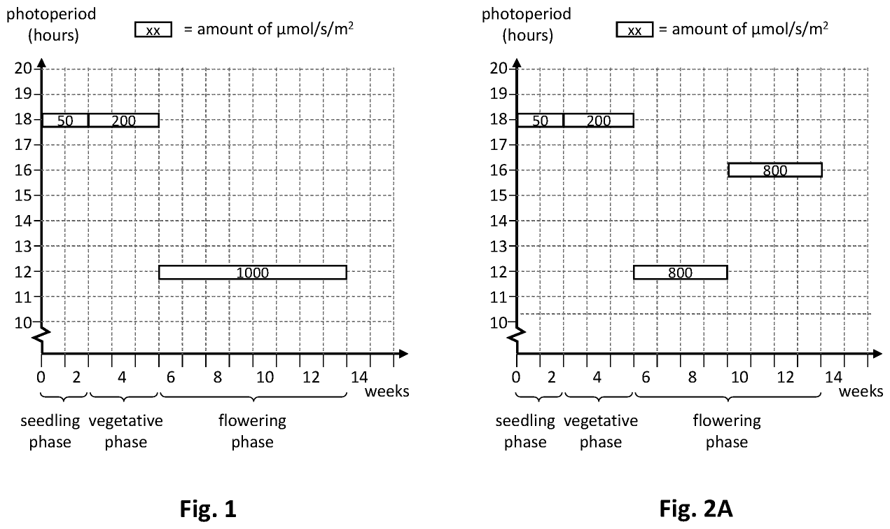

FIG. 1 is a diagram illustrating a method for providing light to a Cannabis plant. Such diagram may also be referred to as a lighting scheme. FIG. 1 illustrates a lighting scheme of a prior art method. In the lighting scheme illustrations in this disclosure, the vertical axis represents the photoperiod in hours and the horizontal axis represents the number of weeks of plant growth, wherein the zero value corresponds to the moment that the propagation phase of the Cannabis plant is initiated. This is day 0 of the growth cycle. As an example, the diagram of FIG. 1 indicates that during the first five weeks, i.e., during the seedling and vegetative phase, a photoperiod of 18 hours per day is applied. Then, from week 6 onwards until harvest, i.e., during the flowering phase, a photoperiod of 12 hours is applied. The numbers inside of the bars indicate the Photosynthetic Photon Flux Density (PPFD), to which the Cannabis plant is exposed. PFFD is indicative of the number of photons in the 400 to 700 nm wavelength range (in embodiments extended to 800 nm to include additional far-red) received by the plant. In the lighting scheme illustrations of this disclosure, PFFD is expressed as the amount of micromole per second per meter squared as indicated. Thus, in addition, the diagram of FIG. 1 indicates that during the first two weeks, during the so-called seedling stage of the Cannabis plant, the PFFD to which the Cannabis plant is exposed is 50 μmol/s/m², whereas during weeks 3-5, i.e. during the so-called vegetative stage of the Cannabis plant, the plant is exposed to 200 μmol/s/m² and during weeks 6-13, i.e. during the flowering stage of the Cannabis plant, the plant is exposed to 1000 μmol/s/m². Note that the latter PFFD value requires light sources that can generate light of relatively high intensities. It should be appreciated that these PPFD values are exemplary. Some species may require +−15% of these mentioned values, for example.

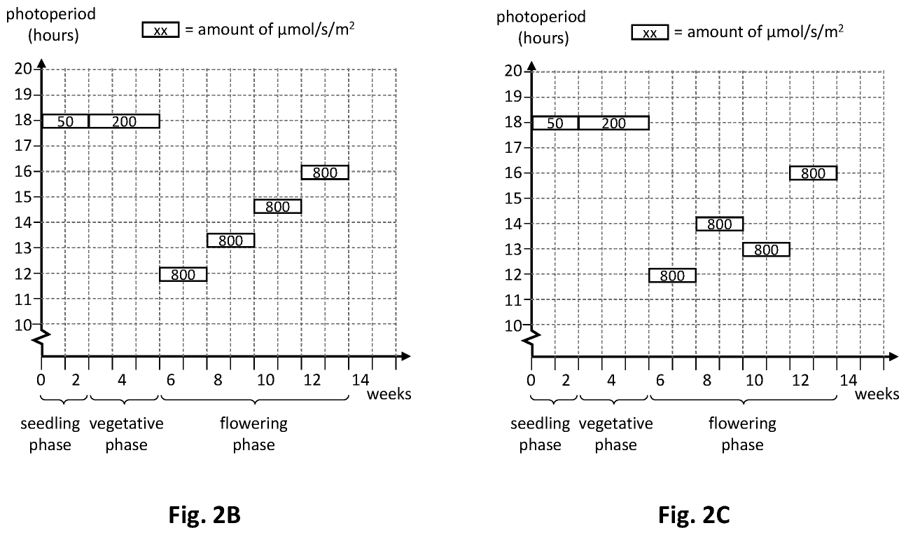

FIG. 2A is a diagram illustrating a method for providing light to a Cannabis plant according to an embodiment of the invention. Herein, during a first time period of a flowering stage of the Cannabis plant, in this case during weeks 6-9, a horticultural illumination system is controlled to provide horticulture light, e.g. horticulture light #3 as indicated in Table I, to the Cannabis plant such that the plant is exposed to a first photoperiod, in this case to a photoperiod of 12 hours. Thereafter, during a second time period of the flowering stage of the Cannabis plant, in this case during weeks 10-13, the horticultural illumination system is configured to provide horticulture light to the Cannabis plant such that the Cannabis plant is exposed to a second photoperiod that is longer than the first photoperiod, in this case a photoperiod of 16 hours.

According to the prior art lighting scheme of FIG. 1, the plant receives, throughout the eight weeks of flowering, horticulture light during 672 hours (8 weeks*7 days*12 hours). However, according to the lighting scheme of the embodiment of FIG. 2A, the plant receives, throughout the eight weeks of flowering, horticulture light during 784 hours (4 weeks*7 days*12 hours+4 weeks*7 days*16 hours). Thus, with the method according to FIG. 2A, the plant receives light for an additional 112 hours with respect to the method of FIG. 1. One advantage of the additional light exposure time is that the light intensity in terms of PFFD value may be selected lower, 800 μmol/s/m² in this example instead of 1000 μmol/s/m² in the prior art example, while still being able to provide an appropriate total amount of photosynthetically active photons throughout the flowering stage. Hence, the methods disclosed herein enable to lower the technical requirements for the light sources of the illumination system, in particular to lower the PFFD that the light sources should be able to provide. It should be appreciated that the lengths of the seedling phase, vegetative phase and flowering phase as indicated in the lighting schemes in this disclosure are indicative. Some cultivars, for example, require an extension of the flowering stage to ten weeks. Another advantage of Cannabis plants receiving light for longer time periods as compared to prior art lighting schemes is that the plants receive more photosynthetically active photons per day (assuming a PFFD level as used in prior art lighting schemes), which may shorten the flowering stage, i.e. shorten the time it takes for the flowers to fully develop and reach a state in which they are ready for harvest. Understandably, shortening the time-to-harvest improves the overall yield of a Cannabis farm.

Preferably, during the first time period of the flowering stage, the photoperiod is between 10 hours and 14 hours, preferably approximately 12 hours, so that the flowering phase is induced and continued, at least until flowering is irreversible. As the flowering phase is induced by a relatively short photoperiod, the flowering typically begins some time, typically two weeks, after the photoperiod has been reduced. This may further depend on the radiant power of the provided illumination. If the applied light level is too low, an additional week might be needed. Also the beginning of flowering may also depend on the cultivar and vary +−5 days.

The first time period may be the first time period of the flowering stage. Further, the first time period in which the first photoperiod is provided may last for 2 to 6 weeks. This limits the risk of the Cannabis plant reverting back to the vegetative phase.

Preferably, the second photoperiod is between 1 and 5 hours longer than said first photoperiod.

The flowering stage in FIG. 2A may be understood to consist of N subsequent time periods {n_₁; n_₂; . . . ; n__{N-1}, n__{N}}, N being an integer number higher than 1. In the case of FIG. 2A, N is 2 and the first time period n_₁ is from 6-9 weeks is and the second time period n_₂ is from week 10-13. When the photoperiod to which the Cannabis plant is exposed during time period nₖ, with k being an integer number, is referred to as tₖ, then in the case of FIG. 2A, t₁=12 hours and t₂=16 hours. In the methods described herein, for at least a pair of time periods consisting of time period nₖ and subsequent time period nₖ₊₁, tₖ₊₁ is different from tₖ. In this case tₖ₊₁>tₖ.

n__{N} may be understood to be that last time period of the flowering stage. During this time period, the photoperiod is preferably relatively long, e.g. preferably longer than 15 hours, more preferably approximately 16 hours.

FIG. 2B is a diagram illustrating another embodiment. Herein, the photoperiod is increased several times during the flowering stage. In the depicted diagram, the photoperiod is increased three times, however, the photoperiod may also be increase twice, or even four times, five times or even more times.

As a result, the horticulture light system is controlled such that the flowering stage comprises at least a first time period (weeks 6-7), a second time period (weeks 10-11) and a third time period (weeks 12-13), wherein the photoperiod of the third time period (16 hours) is longer than the photoperiod of the second time period (14.75 hours) and wherein the photoperiod of the second time period is longer than the photoperiod of the first time period (12 hours).

In particular, FIG. 2B illustrates an embodiment wherein the flowering stage comprises at least three time periods consisting of time period nₖ, subsequent time period nₖ₊₁ and subsequent time period nₖ₊₂, tₖ₊₂>tₖ₊₁>tₖ. The photoperiod is thus gradually increased.

FIG. 2C is a lighting scheme diagram illustrating yet another embodiment. In this embodiment, again the flowering stage comprises at least three time periods, in time occurring after each other and having increasing photoperiods, i.e. a first time period (weeks 6 & 7), a second time period (weeks 8 & 9) and a fourth time period (weeks 12 & 13). However, in this embodiment, the photoperiod not only increases from one time period to the next time period, but in one occasion also decreases from one time period to the next time period. Note that the photoperiod for a third time period (weeks 10 & 11) is 13 hours, which is shorter than the photoperiod of the second time period (weeks 8 & 9) which is 14 hours. The earlier described advantageous effect of increasing the production rate, relative to the prior art, also occurs if the photoperiod is reduced at some point during the flowering phase because, as compared to prior art lighting schemes, the overall average photoperiod that is used during the flowering stage is increased. Reducing the photoperiod at some point during the flowering phase may be beneficial because herewith the plant receives a trigger to remain in the flowering stage thus preventing that the plant reverts back to the vegetative phase. In an embodiment, the method comprises determining that the plant is prone to and/or is starting to revert back to the vegetative phase, for example by monitoring one or more parameters of the plant, such as plant height and/or length of the main stem, and, based on this determination, reducing the photoperiod. The shortening of the photoperiod may also be used to slow down the development of the flowers. This allows, at least to some extent, control the time at which the flowers are ready for harvest.

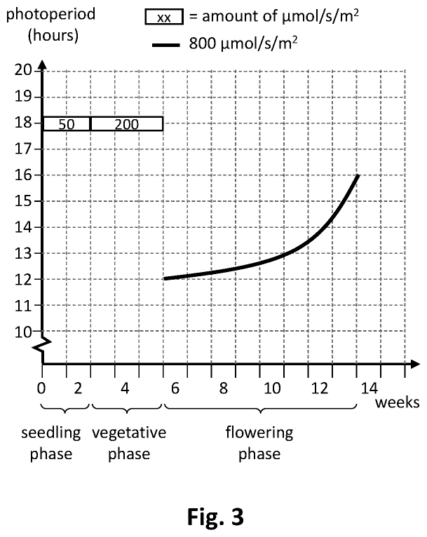

FIG. 3 illustrates that the photoperiod may also vary (almost) continuously in the sense that it may vary from day to day during the flowering stage. It is not required that the photoperiod remains constant throughout a period of more than one day. Note that a photoperiod may be defined as the amount of time per day that a plant is exposed to light. If the photoperiod is different for each day, then each day may be understood to be a time period n_ₖ as referred to herein.

It should be appreciated that an appropriate lighting scheme for a specific cultivar may be found by testing different lighting schemes on respective plants, wherein in each lighting scheme the photoperiod is increased in different ways, and testing the yield of each plant at harvest.

The inventors have conducted trials to proof the effects of the herein described methods. The trial conditions are listed in Table 2 below. Different lighting schemes have been tested wherein a 2 weeks photoperiod extension, a 4 weeks photoperiod extension and a 6 weeks photoperiod extension prior to the harvest time were compared to a control trial wherein no photoperiod extensions are applied (comparable to prior art lighting schemes). Horticulture light with a spectral composition of 11% blue, 6% green and 83% red at an intensity of 620 μmol/s/m² was used throughout the trials.

TABLE 2
lighting schemes indcated with photoperiod (hours) and light intensity (μmol/s/m²).

| | Vegetative | | | | | | | | |
|---|---|---|---|---|---|---|---|---|---|
| Lighting | Phase | Flowering phase | | | | | | | |
| scheme | (11 days) | week 1 | week 2 | Week 3 | Week 4 | Week 5 | Week 6 | Week 7 | Week 8 |
| SD8-LD0 | 18 h 400 | 12 h 620 | 12 h 620 | 12 h 620 | 12 h 620 | 12 h 620 | 12 h 620 | 12 h 620 | 12 h 620 |
| Control | | | | | | | | | |
| SD6-LD2 | 18 h 400 | 12 h 620 | 12 h 620 | 12 h 620 | 12 h 620 | 12 h 620 | 12 h 620 | 18 h 620 | 18 h 620 |
| SD4-LD4 | 18 h 400 | 12 h 620 | 12 h 620 | 12 h 620 | 12 h 620 | 18 h 620 | 18 h 620 | 18 h 620 | 18 h 620 |
| SD2-LD6 | 18 h 400 | 12 h 620 | 12 h 620 | 18 h 620 | 18 h 620 | 18 h 620 | 18 h 620 | 18 h 620 | 18 h 620 |

Legend: SDX-LDY = X weeks of Short Day and Y weeks of Long Day.

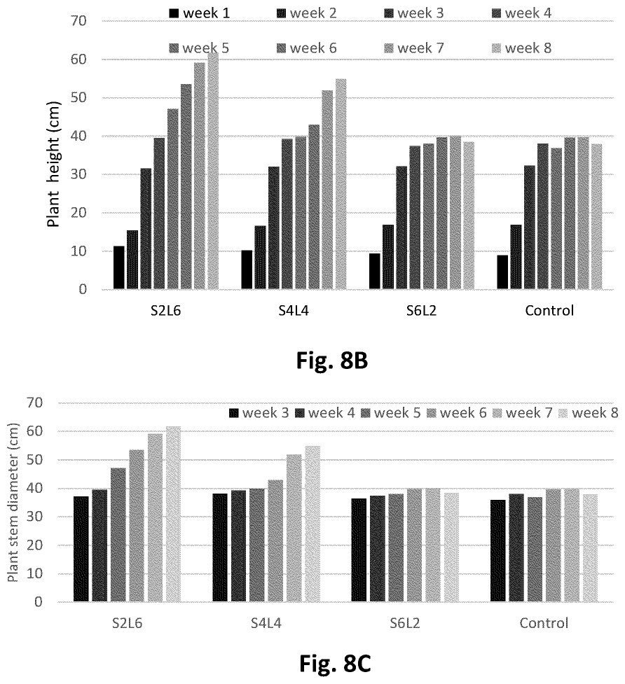

The results are shown in FIGS. 8A to 8C, wherein the labels SXLY refer to lighting schemes SDX-LDY of Table 2 above. FIG. 8A shows the yield results in terms of flower dry weight measured at 12% RH (bar graph) and (extrapolated) kg/m²/year of harvested flowers (line graph). The graph shows that when the photoperiod is switched to 18 hours too early (S2L6), i.e. before the flowering has been settled, the plant continues its vegetative growth and flower production is reduced. FIG. 8B depicts the evolution and settling of plant height during the flowering phase. The graph shows that when the photoperiod is switched to 18 hours too early (S2L6), i.e. before the flowering has been settled, the plant continues its vegetative growth and plant height increases. FIG. 8C depicts the evolution and settling of plant stem diameter during the flowering phase. The graph shows that plants switching back to the vegetative phase (S2L6) continue growing their stem diameter whereas plants that remain in their flowering phase (S4L4 and S6L2) do not show a significant increase in stem diameter.

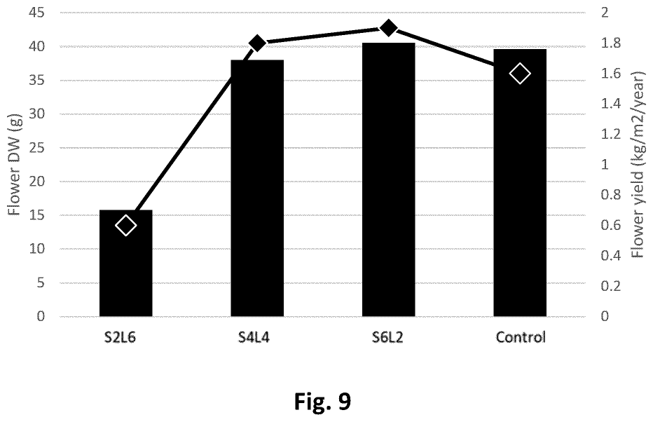

The inventors further conducted trials with the lighting schemes presented in Table 2 but with a different light condition provided in the extension period. In these trials, the indication “18 h 620” means an extended photoperiod of 12 hours of horticulture light with spectral composition (11% blue+6% green+83% red) at a light intensity of 620 μmol/s/m² followed by 6 hours of 100% blue light at a light intensity of 250 μmol/s/m². The results are presented in FIG. 9 in terms of flower dry weight measured at 12% RH (bar graph) and (extrapolated) kg/m²/year of harvested flowers (line graph) and show similar trends as in FIG. 8A. The results indicate that, as also shown in FIG. 8A, switching too soon to a longer photoperiod, i.e. before the flowering has been settled, drives the plants back into vegetative growth and flower production is reduced (see lighting scheme S2L6). Further, in FIG. 9, the positive effects of lighting schemes S4L4 and S6L2 on flower DW and yield are less pronounced than in FIG. 8A, which may be caused by a too low light intensity of blue light used in the photoperiod extensions, i.e. 250 μmol/s/m² in FIG. 9 versus 620 μmol/s/m² in FIG. 8A. It may therefore be expected that 620 μmol/s/m² blue light (instead of 250 μmol/s/m² blue light) applied during the photoperiod extensions provides more pronounced positive effects on flower DW and yield, as verified in the trials described in the next paragraph.

The inventors also conducted trials to compare the yield results from different spectral compositions of the horticulture light applied in the photoperiod extensions. Different spectral compositions were used in the photoperiod extensions with 6 hours during the last 2 weeks of flowering, preceded with 6 weeks of flowering with a non-extended photoperiod of 12 hours. The trial conditions are listed in Table 3 below. In the Table, the indication “12 h 620” means a non-extended photoperiod of 12 hours of horticulture light with spectral composition (11% blue+6% green+83% red) at a light intensity of 620 μmol/s/m². The indication “18 h 620” means an extended photoperiod of 12 hours of horticulture light with spectral composition (11% blue+6% green+83% red) at a light intensity of 620 μmol/s/m² followed by 6 hours of either 100% blue, 100% red or 100% white with spectral composition (11% blue+6% green+83% red) at a light intensity of 250 μmol/s/m².

TABLE 3
lighting schemes indcated with photoperiod (hours) and light intensity (μmol/s/m2).

| | Vegetative | | | | | | | | |
|---|---|---|---|---|---|---|---|---|---|
| Lighting | phase | Flowering phase | | | | | | | |
| scheme | (11 days) | week 1 | week 2 | week 3 | week 4 | week 5 | week 6 | week 7 | week 8 |
| Control | 18 h 400 | 12 h 620 | 12 h 620 | 12 h 620 | 12 h 620 | 12 h 620 | 12 h 620 | 12 h 620 | 12 h 620 |
| Blue | 18 h 400 | 12 h 620 | 12 h 620 | 12 h 620 | 12 h 620 | 12 h 620 | 12 h 620 | 18 h 620 | 18 h 620 |
| extension | | | | | | | | | |
| Red | 18 h 400 | 12 h 620 | 12 h 620 | 12 h 620 | 12 h 620 | 12 h 620 | 12 h 620 | 18 h 620 | 18 h 620 |
| extension | | | | | | | | | |
| White | 18 h 400 | 12 h 620 | 12 h 620 | 12 h 620 | 12 h 620 | 12 h 620 | 12 h 620 | 18 h 620 | 18 h 620 |
| extension | | | | | | | | | |

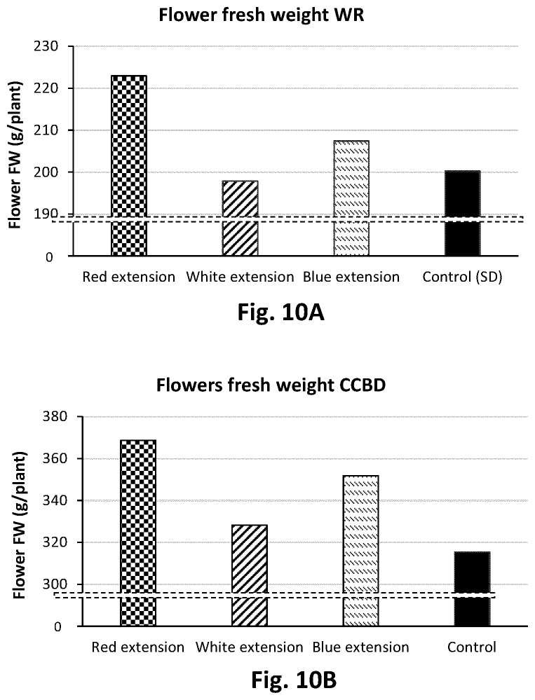

The results are shown in FIGS. 10A and 10B, wherein FIG. 10A shows flower fresh weight for cultivar WR (White Russian) for each of the lighting schemes and FIG. 10B shows flower fresh weight for cultivar CCBD (Critical CBD) for each of the lighting schemes. The figures show that the red extension is the most successful in this experiment and then followed by blue. Note that red LED light also provides a higher wall plug efficiency compared to blue light or white light, allowing further energy saving. In addition, the red light in the photoperiod extension makes the plant more resistant to diseases. Therefore, lighting schemes with a red extension will allow the grower to produce more and save energy while improving quality. Results from the trial also show that the red, blue and white photoperiod extensions do no affect plant height and therefore do not negatively influence the flowering of the plant. (The slightly lower flower fresh weight for White Russian exposed to white photoperiod extensions compared to exposure with the control lighting scheme may be the result of statistical variations. The effect of red light and blue light in the photoperiod extension is clearly visible in the results.)

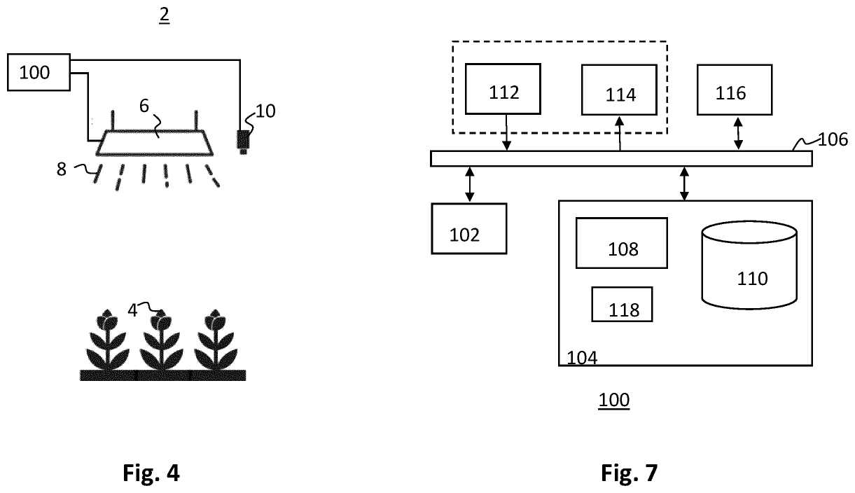

FIG. 4 schematically illustrates a system 2 according to an embodiment for providing light to a Cannabis plant 4. The system 2 comprises a horticulture illumination system 6 configured to provide horticulture light 8 to the Cannabis plant. As used herein, horticulture light 8 may refer to light having a wavelength between 400 nm and 800 nm. The system 2 further comprises a control system 100 that is configured to, during a first time period of a flowering stage of the Cannabis plant, the first time period being one or more days, control the horticultural illumination system 6 to provide horticulture light 8 to the Cannabis plant such that the Cannabis plant is exposed to a first photoperiod. The control system 100 is further configured to, thereafter, during a second time period of the flowering stage of the Cannabis plant, the second time period being one or more days, control the horticultural illumination system 6 to provide horticulture light 8 to the Cannabis plant 4 such that the Cannabis plant is exposed to a second photoperiod, wherein the second photoperiod is longer than the first photoperiod.

Optionally, the system comprises an imaging system 10 that is configured to capture one or more images of at least part of the Cannabis plant 4. Based on these images, the growth stage of the plant can be determined, e.g., vegetative versus flowering, and the sensitivity of the plant to the photoperiod can be determined using the methods described herein.

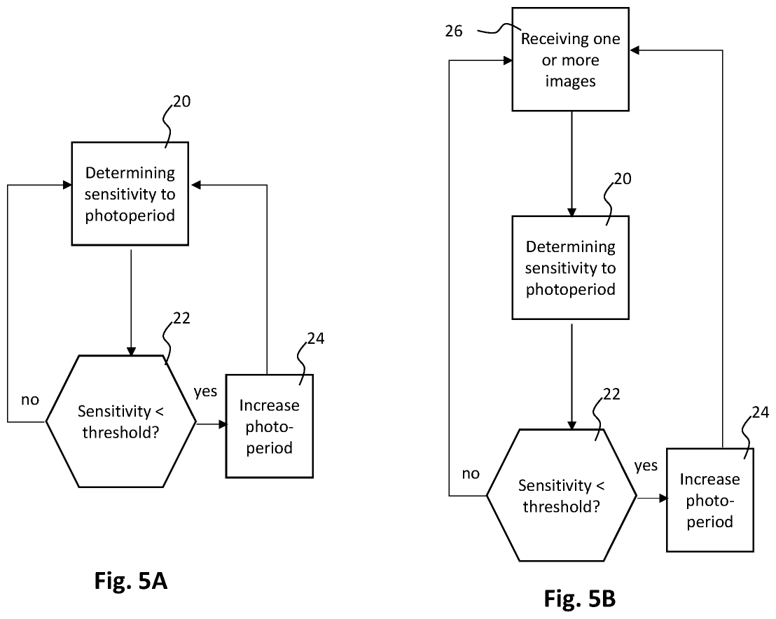

FIG. 5A illustrates a method according to an embodiment, in particular a method that may be executed by a control system as described herein.

A step 20 of this method comprises determining a sensitivity value of the Cannabis plant to the photoperiod during the flowering stage. It should be appreciated that step 20 is an optional step. The beneficial technical effects can be achieved without performing this sensitivity test.

Then, in step 22, the determined sensitivity may be compared with a threshold sensitivity value. If the sensitivity value is below the threshold sensitivity, the horticultural illumination system is controlled to provide horticulture light to the Cannabis plant such that the Cannabis plant is exposed to a longer photoperiod. If it is determined in step 22 that the sensitivity value of the plant is higher than a threshold sensitivity value, the photoperiod remains unchanged.

It should be appreciated that the threshold value may vary in dependence of the current photoperiod and/or the (envisioned) increase in photoperiod and/or the (envisioned) new photoperiod and/or the spectral composition of the horticulture light provided in the photoperiod or photoperiod extension. For example, for a next increase of the photoperiod to some new level, a new threshold value may be used that is associated with that new photoperiod level. This allows to provide the appropriate photoperiod given a certain sensitivity of the Cannabis plant.

FIG. 5B is a flow chart illustrating another embodiment of a method, in particular of a method executable by a control system as described herein. Steps 20, 22 and 24 have been described with reference to FIG. 5A. However, in this embodiment a step 26 is performed that comprises receiving one or more images of at least part of the Cannabis plant. Then, in optional step 20, the sensitivity value of the plant can be determined based on these captured images. In particular, the growth of the diameter of the stem per unit of time and/or the growth of the length of the Cannabis plant per unit of time can be determined as these are indications of the sensitivity value of the plant to the photoperiod.

Such embodiment may also comprise controlling an imaging system 10 (see FIG. 4) to capture an image of at least part of the Cannabis plant.

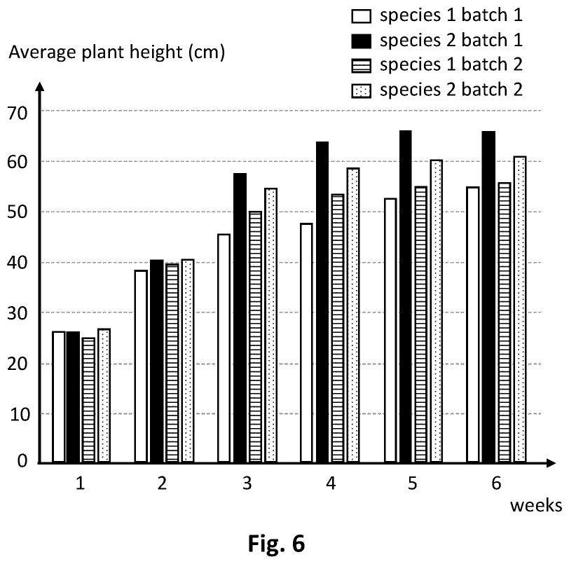

As said, the sensitivity value of the Cannabis plant to the photoperiod can be determined based on the diameter growth of a stem per unit of time and/or based on a growth of a length of the Cannabis plant per unit of time. Indeed, during the transition from the vegetative to flowering stage, the Cannabis plant continues to grow in length while the stem diameter becomes thicker. It is assumed, that while the plant is still growing in length and thickness, it may be more susceptible to switch back to a vegetative growth stage. Monitoring the length and the stem diameter per species could therefore be criteria on which a decision can be based to start increasing the length of the photoperiod (e.g. as a function of the stabilisation of the plant height versus time). The graph in FIG. 6 shows the plant height of two different cultivars from week to week, from the moment flowering has been induced.

FIG. 6 illustrates that the growth of the length of the plant levels out, i.e. the growth rate becomes approximately zero. This is an indication that the Cannabis plant has reached a relatively low sensitivity to the photoperiod. In FIG. 6, the average plant height versus time from the induction of flowering for two different cultivars (species 1 and species 2) is shown. Notice that the plant height stabilises over time.

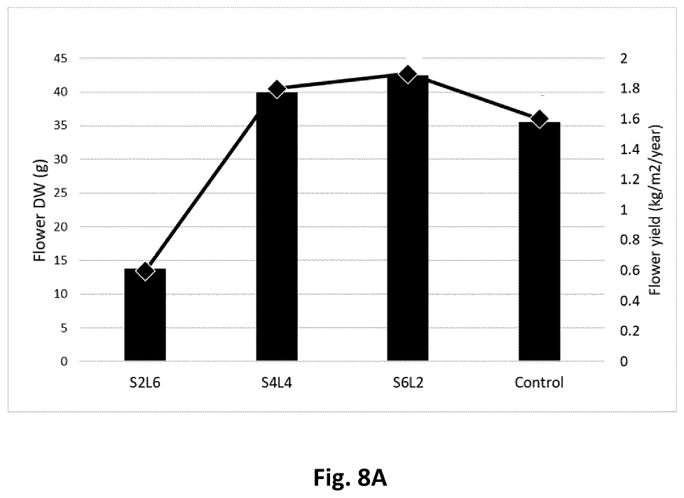

FIG. 7 depicts a block diagram illustrating a data processing system according to an embodiment.

As shown in FIG. 7, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

Input/output (I/O) devices depicted as an input device 112 and an output device 114 optionally can be coupled to the data processing system. Examples of input devices may include, but are not limited to, an imaging system, for example a camera, as described herein that is configured to capture a plurality of images of at least part of the Cannabis plant, a keyboard, a pointing device such as a mouse, a touch-sensitive display, or the like. Examples of output devices may include, but are not limited to, a horticultural illumination system as described herein, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

In one aspect of the present invention, the data processing system 100 may represent a control system as described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method for providing light to a Cannabis plant, the method comprising
during a first time period of a flowering stage of the Cannabis plant, the first time period being one or more days, controlling a horticultural illumination system to provide horticulture light to the Cannabis plant such that the Cannabis plant is exposed to a first photoperiod, and thereafter
during a second time period of the flowering stage of the Cannabis plant, the second time period being one or more days, controlling the horticultural illumination system to provide horticulture light to the Cannabis plant such that the Cannabis plant is exposed to a second photoperiod,
wherein the second photoperiod is longer than the first photoperiod and wherein an increase in photoperiod from the first photoperiod to the second photoperiod does not cause the Cannabis plant to revert back to a vegetative phase, and wherein a photoperiod is defined as an amount of time that a plant is exposed to light in a period of 24 hours wherein said period of 24 hours also includes a time of darkness.

2. The method according to claim 1, further comprising
during a third time period of the flowering stage of the Cannabis plant, the third time period occurring later than the second time period, the third time period being one or more days, controlling the horticultural illumination system to provide horticulture light to the Cannabis plant such that the Cannabis plant is exposed to a third photoperiod, wherein the third photoperiod is longer than the second photoperiod.

3. The method according to claim 1, wherein the first photoperiod is between 10 hours and 14 hours and wherein the second photoperiod is between 1 and 5 hours longer than said first photoperiod.

4. The method according to claim 1, wherein the first time period lasts for 2 to 6 weeks.

5. The method according to claim 1, wherein:
the flowering stage consist of N subsequent time periods {n_₁; n_₂; . . . ; n__{N-1}; n__{N}}, N being an integer number higher than 1, the first time period being any of the time periods {n_₁; n_₂; . . . ; n__{N-1}} and the second time period being any of the time periods {n_₂; . . . ; n__{N-1} n__{N}} after the first time period, wherein the method comprises
during each time period of the N subsequent time periods {n_₁; n_₂; . . . ; n__{N-1} n__{N}}, controlling the horticultural illumination system to provide horticulture light to the Cannabis plant such that the Cannabis plant is exposed to a photoperiod tₖ, wherein k is an integer number and tₖ indicates the photoperiod for the k^{th} time period of the N subsequent time periods,
wherein for at least a pair of time periods consisting of time period nₖ and subsequent time period nₖ₊₁, tₖ₊₁ is different from tₖ.

6. The method according to claim 5, wherein for at least a trio of time periods consisting of time period nₖ, subsequent time period nₖ₊₁ and subsequent time period nₖ₊₂, tₖ₊₂>tₖ₊₁>tₖ.

7. The method according to claim 5, wherein t_{N}>15 hours.

8. The method according to claim 1, further comprising controlling the horticultural illumination system to provide, during at least part of the second photoperiod, horticulture light with a different spectral composition compared to the horticulture light provided during the first photoperiod.

9. The method according to claim 8, wherein the at least part of the second photoperiod comprises a photoperiod extension, defined as additional hours of exposing the Cannabis plant to horticulture light during the second photoperiod compared to the first photoperiod.

10. The method according to claim 1, further comprising:
during the first time period, determining a sensitivity value of the Cannabis plant to the photoperiod, and
based on a determination that the determined sensitivity value is below a threshold sensitivity value, starting the second time period and controlling the horticultural illumination system to provide horticulture light to the Cannabis plant such that the Cannabis plant is exposed to the second photoperiod.

11. The method according to claim 10, comprising
during the first time period, determining a growth of a diameter of a stem per unit of time of the Cannabis plant and/or determining a growth of a length of the Cannabis plant per unit of time, and
based on the determined diameter growth and/or the determined length growth, determining the sensitivity of the Cannabis plant to the photoperiod.

12. The method according to claim 10, wherein determining the growth of the diameter of the stem per unit of time and/or the growth of the length per unit of time comprises determining the growth of the diameter of the stem per unit of time and/or the growth of the length per unit of time based on one or more images representing at least part of the Cannabis plant.

13. A system for providing light to a Cannabis plant, the system comprising
a horticulture illumination system configured to provide horticulture light to the Cannabis plant, and
a control system that is configured to
during a first time period of a flowering stage of the Cannabis plant, the first time period being one or more days, control the horticultural illumination system to provide horticulture light to the Cannabis plant such that the Cannabis plant is exposed to a first photoperiod, and to thereafter
during a second time period of the flowering stage of the Cannabis plant, the second time period being one or more days, control the horticultural illumination system to provide horticulture light to the Cannabis plant such that the Cannabis plant is exposed to a second photoperiod,
wherein the second photoperiod is longer than the first photoperiod and wherein an increase in photoperiod from the first photoperiod to the second photoperiod does not cause the Cannabis plant to revert back to a vegetative phase, and wherein a photoperiod is defined as an amount of time that a plant is exposed to light in a period of 24 hours wherein said period of 24 hours also includes a time of darkness.

14. A non-transitory computer readable medium comprising instructions which, when the instructions are executed by a control system, causes the control system to perform the method according to claim 1.

15. (canceled)
